(19) United States
(12) Patent Application Publication
(10) Pub. No.: US 2017/0001611 A1
(43) Pub. Date: Jan. 5, 2017

(54) METHOD AND DEVICE FOR OPERATING A MOTOR VEHICLE, MOTOR VEHICLE

(71) Applicant: Robert Bosch GmbH, Stuttgart (DE)

(72) Inventor: Matthaeus Koch, Talheim (DE)

(21) Appl. No.: 15/194,708

(22) Filed: Jun. 28, 2016

(30) Foreign Application Priority Data
Jul. 1, 2015 (DE) 102015212300.6

(51) Int. Cl. B60T 8/175; B60T 8/1761; B60K 1/00

(52) U.S. Cl. CPC B60T 8/175; B60K 1/00; B60T 8/1761

(57) ABSTRACT

A method for operating a motor vehicle, which has at least one electric drive motor, which is connected/connectible to at least one drive axle having two drive wheels, wheel brakes assigned to the drive wheels being controlled by an anti-lock braking system for building up respectively one ABS braking force for a braking process. The invention provides for varying an ABS braking force buildup on one of the drive wheels when the other of the drive wheels of the drive axle exhibits a critical slip.

### CROSS REFERENCE

The present application claims the benefit under 35 U.S.C. §119 of German Patent Application No. DE 102015212300.6 filed on Jul. 1, 2015, which is expressly incorporated herein by reference in its entirety.

### FIELD

The present invention relates to a method for operating a motor vehicle, which has at least one electric drive motor, which is connected/connectible to at least one drive axle having two drive wheels, wheel brakes assigned to the drive wheels being controlled by an anti-lock braking system for building up respectively one ABS braking force for a braking process.

The present invention furthermore relates to a device for operating such a motor vehicle as well as to a corresponding motor vehicle.

### BACKGROUND INFORMATION

Methods, devices and motor vehicles for busing up ABS braking forces are available. The increasing electrification of the drive train of motor vehicles requires that motor vehicles having an electric drive also have the same safety systems as conventional drive devices having an internal combustion engine. Thus, conventional safety systems, such as in particular the anti-lock braking system (ABS), are used even in drive devices that have an electric drive motor. In the case of an electrically driven axle, however, the wheels may behave differently than in the case of a drive axle couplable/coupled to an internal combustion engine. This is due to the stiff dynamics of the electric motor. In an ABS braking process, there may be a self-reinforcing increase of asynchronous vibrations on the two drive wheels of the drive axle, which on the one hand reduce comfort and on the other hand put much stress on components of the motor vehicle, in particular of the drive train and of the wheel suspension.

Such vibrations arise on account of a transmission of force from one of the drive wheels via the differential having a coupled electric, dynamically stiff motor to the other drive wheel of the same drive axle. When, for example, one of the drive wheels reaches a critical slip state, then the anti-lock braking system reduces the braking force on this drive wheel such that it accelerates again. The force for this acceleration derives from the road surface and is transmitted via the differential to the other drive wheel of the same drive axle, where, due to the dynamically stiff electric motor, it acts as an additional braking force or braking torque component, which has the effect that the other drive wheel may also reach a critical slip state. The brake pressure reduction that is now necessary on the other wheel results in its renewed acceleration and in the process at the same time brakes the one drive wheel. In this manner, it is possible that asynchronous vibrations arise and reinforce each other.

### SUMMARY

An example method of the present invention may have the advantage of safely preventing the mutual reinforcement and generation of such asynchronous vibrations. For this purpose, the method according to the present invention provides for varying an ABS braking force buildup on one of the drive wheels in the braking process if the other of the drive wheels of the drive axle exhibits a critical slip. During the ABS operation, the drive wheels of the drive axle are thus monitored for critical slip states. If a critical slip occurs in one of the drive wheels, then the braking force provided by the anti-lock braking system is varied on the other drive wheel such that it in particular does not increase further in accordance with the actual ABS control. This safely prevents a self-reinforcing increase of the vibrations. If the critical slip is detected in a timely manner, then it is possible to prevent the occurrence of an asynchronous vibration on the drive axle from the start.

Preferably, there is furthermore a provision for monitoring a wheel speed of the respective drive wheel in order to detect the critical slip. In particular, a wheel speed curve of the drive wheels is monitored in order to detect the occurrence of a critical slip. For this purpose, it is possible for example also to compare the respectively detected wheel speed with a driving speed of the motor vehicle in order to compare whether the detected wheel speed matches the driving speed.

The present invention, however, particularly preferably provides for a critical slip to be detected when a wheel speed gradient of one of the detected wheel speeds exceeds a specifiable limit value. If the wheel speed changes abruptly for example, then it is possible to infer that the wheel has switched from a state with little slip to a state with critical slip or vice versa. Accordingly, the measures of the present invention for preventing the asynchronous vibrations are initiated if the wheel speed gradient exceeds the specified limit value.

The present invention furthermore preferably provides for the ABS braking force buildup to be varied by delaying a braking force increase. A delayed braking force increase thus occurs on the other drive wheel such that, at the point in time at which the additional braking force component occurs on the other wheel due to the reduced braking force on the one wheel, no additional braking force is generated such that the scenario described at the outset is avoided.

The delayed braking force buildup allows for the one wheel, at which the critical slip has occurred, to be brought into a safe state without a change in the braking force occurring at the other wheel. The delay time may be firmly specified for this purpose or may be specified as a function of the critical slip of the one wheel for example.

An alternative specific embodiment preferably provides for the ABS braking force buildup to be varied by an at least brief reduction of the braking force. Here it is thus not only provided to delay the further increase of the braking force, but rather to reduce the braking force already set on the other wheel. This makes it possible for example to compensate for the additional braking torque component that is transmitted by the differential from the one wheel to the other wheel. The occurrence and the self-reinforcing increase of asynchronous vibrations are thus prevented early.

A preferred development of the present invention provides for the length of time of the variation of the ABS braking force buildup to be determined as a function of the detected wheel speed. This makes it possible to adapt the braking force buildup in an optimized manner to the current driving situation in order to prevent or reduce the asynchronous vibrations by the variation.

Alternatively, the present invention preferably provides for the length of time of the variation to be specified as constant. This reduces the computing and control expenditure and nevertheless already offers good protection against the self-reinforcing increase of asynchronous vibrations.

An example device according to the present invention includes a specially prepared control unit that implements the method of the present invention. This yields the advantages already mentioned.

An example motor vehicle according to the present invention includes the example device of the present invention. This yields the advantages already mentioned.

### BRIEF DESCRIPTION OF THE DRAWINGS

Below, the present invention is explained greater detail with reference to the figures.

FIG. 1 shows a drive device of a motor vehicle in a simplified top view.

FIG. 2 shows a method for operating the motor vehicle.

### DETAILED DESCRIPTION OF EXAMPLE EMBODIMENTS

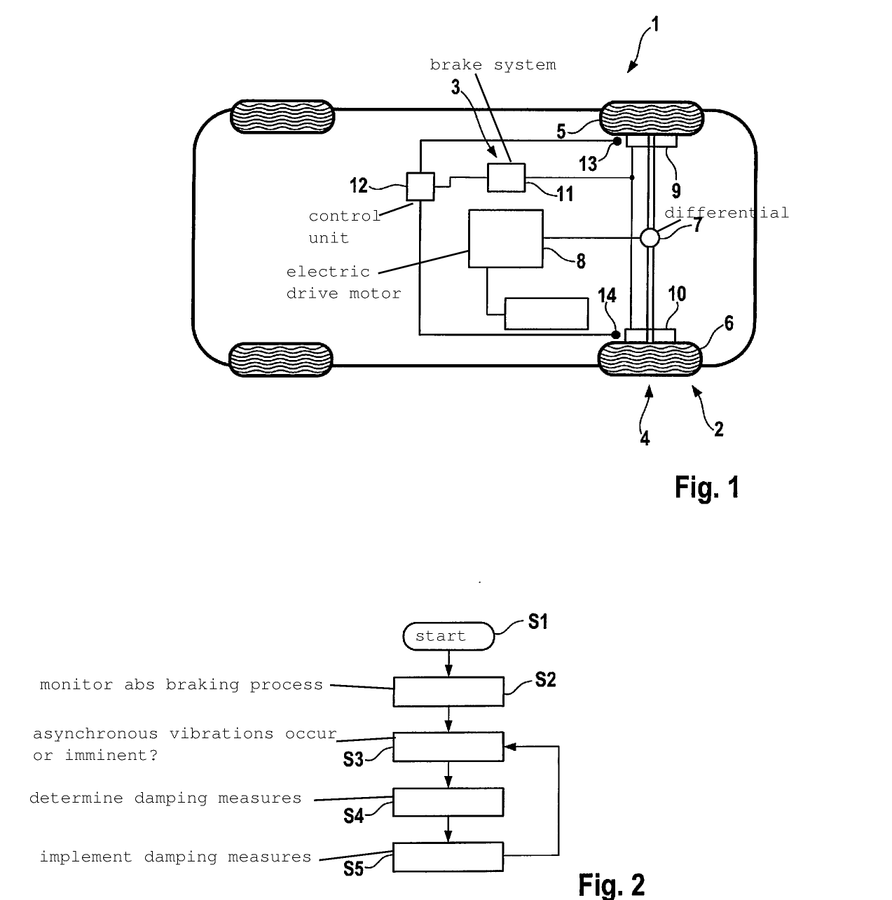

In a simplified top view, FIG. 1 shows a motor vehicle 1, which includes a drive device 2 and a brake system 3.

Drive device 2 has a drive axle 4 having two drive wheels 5, 6, which are operatively connected to one another by a differential 7. According to another exemplary embodiment not shown here, it is also possible to provide for the drive device 2 to be separable from the drive axle 4 by a clutch or the like. The differential 7 is also coupled to an electric drive motor 8.

Brake system 3 has wheel brakes 9, 10, which are respectively assigned to one of drive wheels 5, 6. Wheel brakes 9, 10 are in particular operable hydraulically. For this purpose, brake system 3 has an anti-lock braking system 11, which is connected hydraulically to wheel brakes 9, 10 in order to control the latter hydraulically for generating a braking force. Anti-lock braking system 11 is developed as an ABS brake system that controls wheel brakes 9, 10 in a braking process in such a way that a slip of drive wheels 5, 6 is avoided. For this purpose, anti-lock braking system 11 builds up the braking force on the respective wheel brakes 9, 10 until a critical slip state of drive wheels 5, 6 is reached. Anti-lock braking system 11 then either reduces the braking force or prevents a further braking force buildup on wheel brakes 9, 10.

Motor vehicle 1 furthermore has a control unit 12, which is connected to anti-lock braking system 11 or is integrated in it. Control unit 12 is also connected to wheel speed sensors 13, 14, which are respectively assigned to one of drive wheels 5, 6.

With reference to FIG. 2, an advantageous method for operating motor vehicle 1 is now explained in greater detail. The method begins in step S1 when the motor vehicle is taken into operation. In subsequent step S2, control unit 12 monitors brake system 3 to determine whether an anti-lock braking process (ABS braking process) occurs. If a braking process of this type is detected, then an ascertainment is made in subsequent step S3 as to whether asynchronous vibrations occur or are imminent on drive axle 4. Asynchronous vibrations may arise on account of a transmission of force from one of the drive wheels via differential 7 having a coupled electric drive motor 8, which acts in a dynamically stiff manner, to the other drive wheel of the same drive axle 4. If for example with reference to the exemplary embodiment from FIG. 1 the drive wheel 5 exhibits a critical slip state, then anti-lock braking system 11 normally reduced the braking force on this drive wheel in order to accelerate it again so as to reduce the slip. The force for the acceleration of drive wheel 5 then derives from the road surface, on which motor vehicle 1 is moving, and is transmitted via the differential, which is dynamically stiff when electric motor 8 is coupled, at least partially to the other side of the vehicle or to the other drive wheel 6. There, the transmitted force acts as an interfering or additional braking force component. The latter in turn results in the possibility of drive wheel 6 itself entering a critical slip state. The brake pressure reduction that is now necessary on the drive wheel 6 results in a renewed acceleration of drive wheel 6 and in the process at the same time in turn brakes drive wheel 5. In this manner, it is possible that the asynchronous vibrations arise and increase in a self-reinforcing manner.

In step S3, drive wheels 5, 6 are therefore first monitored for critical slip. For this purpose, the wheel speeds of drive wheels 5, 6 are monitored using wheel speed sensors 13, 14. In particular, the respective speed curve is checked for critical speed gradients. For this purpose, detected speed gradients are compared in particular to a limit value in order to detect a critical slip. Fundamental criteria for ascertaining an imminent asynchronous vibration are thus for example the wheel slip and the wheel dynamics of drive wheels 5, 6. When specifiable thresholds are exceeded, it is then possible to infer a need for damping in order to dampen or prevent the vibrations.

In step S4, damping measures and their intensity and/or duration are determined. One possible damping measure is the short-term prevention of braking pressure increases by anti-lock braking system 11, in particular in phases in which the run-up of the one drive wheel 5 causes a transmission of force to the other drive wheel 6. The aim is to prevent drive wheel 6 from reaching a critical slip. Thus for this purpose the controlled operation of anti-lock braking system 11 is varied in that a further braking force increase is delayed. The delay time may be firmly specified for this purpose or may be specified as a function of the wheel speeds, for example.

An alternative damping measure is a predictive braking force reduction on drive wheel 6, with the aim of preventing a critical slip on drive wheel 6. In particular, the predictive braking force reduction compensates for the additional braking torque component transmitted via the differential. This prevents the emergence or self-reinforcing increase of an asynchronous vibration.

The duration of the delay or the magnitude of the braking force reduction maybe set for example to be a function of the wheel curve, with respect to slip and dynamics, of the re-accelerated drive wheel 6. Applicable fixed values for the hold time/delay time or for the braking force reduction are also conceivable.

In step S5, the damping measure decided in step S4 is implemented and the result is monitored by a feedback to step S3.

The advantageous method thus influences the ABS braking force control by preventive delay phases and/or braking force reductions so as to prevent critical slip phases due to a re-accelerated drive wheel 5 or 6 on the other side of drive axle 4. An asynchronous vibration of drive wheels 5, 6 of drive axle 4 may thus be avoided or at least reduced/damped. Optionally, the described method is implemented only when the drive device 2 is connected to drive axle 4.

What is claimed is:

1. A method for operating a motor vehicle, which has at least one electric drive motor connected/connectible to at least one drive axle having two drive wheels, controlling wheel brakes assigned to the drive wheels being controlled in a braking process by an anti-lock braking system for building up respectively an ABS braking force, the method comprising:
varying the ABS braking force buildup on one of the drive wheels if the other of the drive wheels of the drive axle exhibits a critical slip.

2. The method as recited in claim 1, wherein a wheel speed of the respective drive wheel is monitored in order to detect the critical slip.

3. The method as recited in claim 2, wherein the critical slip is detected when a wheel speed gradient of a detected wheel speed exceeds a specifiable limit.

4. The method as recited in claim 1, wherein the ABS braking force buildup is varied by delaying a braking force increase.

5. The method as recited in claim 1, wherein the ABS braking force buildup is varied by an at least brief reduction of the braking force.

6. The method as recited in claim 1, wherein a length of time of the variation of the ABS braking force buildup is determined as a function of at least one of the detected wheel speeds.

7. The method as recited in claim 1, wherein the length of time of the variation of the ABS braking force buildup is specified as constant.

8. A device for operating a motor vehicle, the motor vehicle having at least one electric drive motor connected/connectible to at least one drive axle having two drive wheels, wheel brakes assigned to the drive wheels being controlled in a braking process by an anti-lock braking system for building up respectively an ABS braking force, the device comprising:
a control unit configured to vary the ABS braking force buildup on one of the drive wheels if the other of the drive wheels of the drive axle exhibits a critical slip.

9. A motor vehicle, comprising:
at least one electric drive motor connected/connectible to at least one drive axle having two drive wheels;
a brake system which has a wheel brake for each of the drive wheels, the wheel brakes being controlled in a braking process by an anti-lock braking system for building up respectively an ABS braking force; and
a control unit configured to vary the ABS braking force buildup on one of the drive wheels if the other of the drive wheels of the drive axle exhibits a critical slip.
